(19) United States
(12) Patent Application Publication
(10) Pub. No.: US 2019/0303535 A1
(43) Pub. Date: Oct. 3, 2019

(54) INTERPRETABLE BIO-MEDICAL LINK PREDICTION USING DEEP NEURAL REPRESENTATION

(71) Applicant: INTERNATIONAL BUSINESS MACHINES CORPORATION, Armonk, NY (US)

(72) Inventors: Achille B. Fokoue-Nkoutche, White Plains, NY (US); YINGKAI Gao, White Plains, NY (US); HENG LUO, Ossining, NY (US); PING ZHANG, White Plains, NY (US); Sanjoy Dey, White Plains, NY (US)

(21) Appl. No.: 15/943,773

(22) Filed: Apr. 3, 2018

(51) Int. Cl. G06F 19/24; G06N 5/04; G06N 7/00; G06N 3/08; G06F 17/30; G06N 3/04; G06N 99/00; G06F 17/16

(52) U.S. Cl. CPC G06F 19/24; G06N 5/04; G06N 7/005; G06F 17/16; G06F 17/3069; G06N 3/04; G06N 99/005; G06N 3/08

(57) ABSTRACT

Link prediction for biomedical entities. A neural network is trained using known associations between biomedical entities, including their vector representations and additional information-carrying content describing the biomedical entities. The trained network infers or predicts unobserved associations between two entities.

### BACKGROUND

Embodiments of the invention generally relate to machine learning, and more particularly to neural networks.

Medical and computer scientists and researchers in the biomedical domain increasingly rely on computer technology to perform new tasks, to perform old tasks in new and better ways, or to tackle previously-known (but unsolved) or newly-discovered challenges. Conventional computers and computing techniques, and human ingenuity alone, are inadequate to perform these tasks or to address these challenges.

Several important tasks in the biomedical domain may be described as link prediction tasks. Link prediction is the task of inferring missing links between two or more entities in a network of entities (for example, as represented by a knowledge graph), by learning from observed links between those entities. In the biomedical context, link prediction may be used to perform drug-drug interaction prediction, disease-gene prioritization, and drug-target interaction prediction.

In these link prediction tasks, one objective may be to identify links between two biomedical entities. A biomedical entity generally refers to any composition of matter that is related to the fields of biology and medicine. In the context of computing technology, a biomedical entity is generally representable using a data type, structure, or pattern. Examples of biomedical entities representable via a computer are genes, proteins, amino acids, diseases, and drugs. These are merely examples; other biomedical entities are possible.

### SUMMARY

Embodiments of the invention provide for methods, computer program products, and systems for using a neural network model for determining an association between biomedical entities in a biomedical entity pair. For example, the method, according to an embodiment, generates vector representations of respective tokens of biomedical entities of the biomedical entity pair. The method generates, using a neural network, hidden vectors for the vector representations to generate hidden matrices. The method concatenates the hidden matrices and generating respective concatenated matrices, and correlates the concatenated matrices. The method predicts a probability of an association between the biomedical entities of the biomedical entity pair based at least in part on respective attention vectors generated using the concatenated matrices.

According to an embodiment, the method generates vector representations of biomedical entities of the biomedical entity pairs by processing tokens of the biomedical entities via an embedding lookup layer.

According to an embodiment, a biomedical entity refers to a data representation of a composition of matter that is related to the fields of biology and medicine.

According to an embodiment, the neural network is a Long Short Term Memory (LSTM) recurrent neural network (RNN).

According to an embodiment, correlating the concatenated matrices refers to performing attentive pooling on the concatenated matrices.

According to an embodiment, performing attentive pooling is done using attentive pooling.

According to an embodiment, the attentive pooling comprises row-wise attentive pooling and column-wise attentive pooling.

According to an embodiment, the method generates attention vectors corresponding to the biomedical entity pairs.

According to an embodiment, the steps of the method are repeated iteratively using a training dataset; and the method optimizes parameters of the neural network to maximize the predicted probability of an association for the training dataset.

According to an embodiment, the method processes a new biomedical entity pair not appearing in the training set and for which a prior association is not known; and determining a probability of association between biomedical entities of the new biomedical entity pair.

### BRIEF DESCRIPTION OF THE SEVERAL VIEWS OF THE DRAWINGS

FIG. 1 is a functional block diagram of a link prediction system 100, according to an embodiment of the invention.

FIG. 2 is a functional block diagram 200 of various inputs, outputs, and processing steps of a specific training module 103 of a link prediction program 102 of FIG. 1, according to embodiment of the invention.

FIG. 3 is a flowchart of a method 300 of using specific training module 103 (FIG. 2), according to an embodiment of the invention.

FIG. 4 is a functional block diagram of a knowledge graph 109 for use with the general training module 104 of the link prediction program 102 of FIG. 1, according to an embodiment of the invention.

FIG. 5 is a flowchart of a method 500 of using general training module 104 (FIG. 4), according to an embodiment of the invention.

FIG. 6 is a flowchart of a method 600 of using an inference module 112 of the link prediction program 102 of FIG. 1, according to an embodiment of the invention.

FIG. 7 is a functional block diagram of an overall data flow and neural network architecture, according to an embodiment of the invention.

FIG. 8 is a functional block diagram of hardware and software components of link prediction system 100, according to an embodiment of the invention.

### DETAILED DESCRIPTION

The task of biomedical link prediction generally involves answering the question of whether (or predicting the likelihood that) two biomedical entities under consideration are associated in some way, where the answer is not directly known in a knowledge source (such as a knowledge graph). In this context, a given biomedical entity may be taken as the reference point, and compared against one or more “targets,” i.e., biomedical entities with which the given biomedical entity might be associated. For example, in the more specific task of determining drug-target interactions (DTIs), a question that might be answered is whether a given drug (a chemical compound) is associated with a protein (the target).

Previous approaches to link prediction for pairs of biomedical entities either cannot sufficiently use the rich features of the relevant domain (as reflected, for example, in the entities' matrix factorization), or require extensive domain expertise for feature engineering (for example, similarity-based prediction). More specifically, prior art solutions cannot use both linkage information and content information at the same time. Moreover, prior art solutions do not utilize basic entity information in the general training phase of a neural network, and cannot handle unobserved entities at inference time. Additionally, the prior art does not extend to biomedical entities such as gene sequences, protein sequences, or chemical structures.

Some embodiments of the invention will generally be described in the context of the following three processing phases: a specific neural network training phase (“specific training phase”); a general neural network training phase (“general training phase”); and a neural network inference phase (“inference phase”).

The specific training phase generally refers to a set of functions that receive, as their inputs, a biomedical entity pair; process them using various machine learning techniques including those that use a neural network; and generate an output that represents a likelihood that the two biomedical entities in the biomedical entity pair are associated with one another (the output may also be considered a measure of their association). This process is referred to as “specific” because its output is based on a given biomedical entity pair, and because iterative execution of this specific process forms part of the general training phase (along with other processes).

The general training phase generally refers to a set of functions that process multiple biomedical entity pairs (a training set) and a knowledge graph containing the biomedical entity pairs, where the knowledge graph may include known associations (or lack of associations) between the various biomedical entities that the knowledge graph represents. The biomedical entities and their known associations (or lack of associations) are used, in the general training phase, to train parameters of a link prediction neural network, through iterative execution of the specific training phase and use of machine learning techniques such as gradient descent. Through these processes, the general training phase derives and optimizes the neural network's parameters.

The inference phase generally refers to a set of functions that evaluate a given biomedical entity pair's level of association (whether as a scale or as a binary value) by using the given biomedical entity pair as inputs to the trained neural network, and by receiving an output of the trained neural network. The output represents a measure of association between the biomedical entities of the biomedical entity pair. In this context, the biomedical entity pair under consideration may be new biomedical entities or newly paired biomedical entities, for which a prior association measure is not yet known or observed.

Embodiments of the invention will now be described with greater specificity, in connection with the Figures.

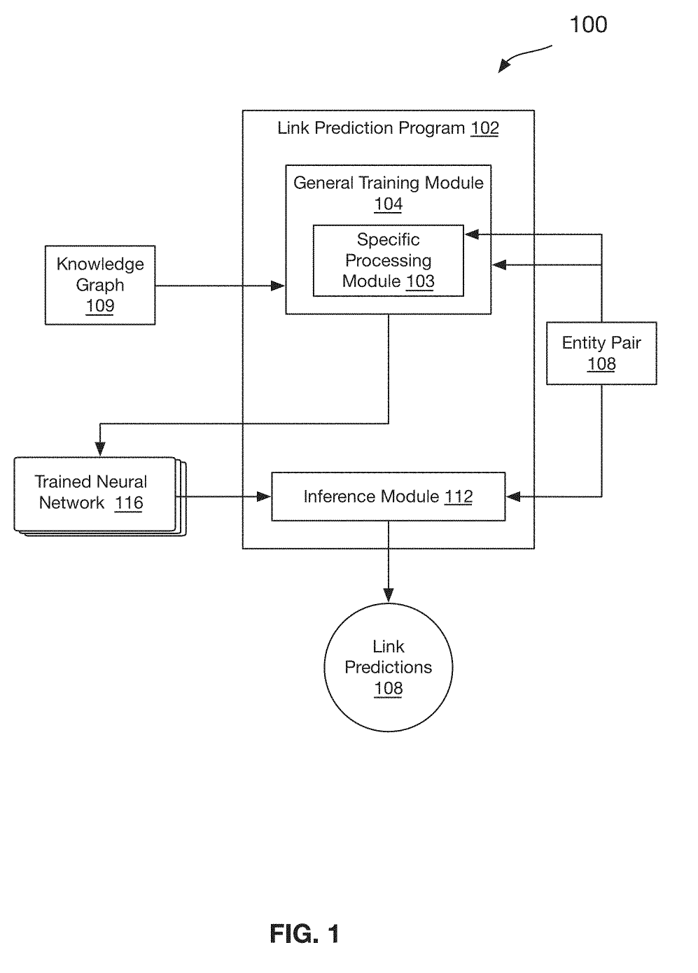

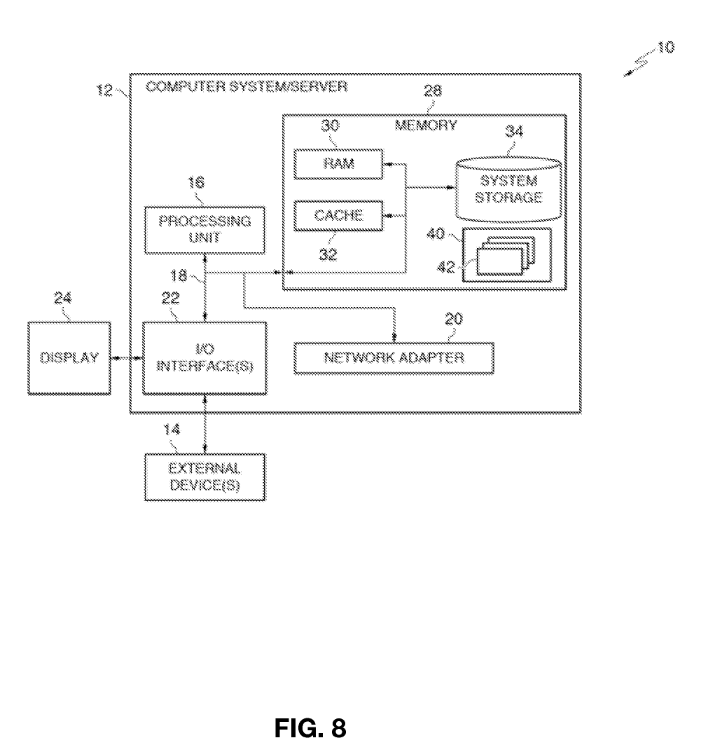

FIG. 1 is a functional block diagram of a link prediction system 100, according to an embodiment of the invention. Link prediction system 100 may be a single computing device or a collection of operatively connected computing devices. Aspects of each such device may be, for example, as provided in FIG. 8, according to an embodiment of the invention.

According to the depicted embodiment, link prediction system 100 includes a link prediction program 102 having one or more modules, including a specific training module 103, a general training module 104, and an inference module 112. Other components of link prediction system 100 include one or more biomedical entity pairs 108, one or more knowledge graphs 109, and one or more trained neural networks 116, stored one more databases (not shown). General properties of these components and their interactions are described in more detail below.

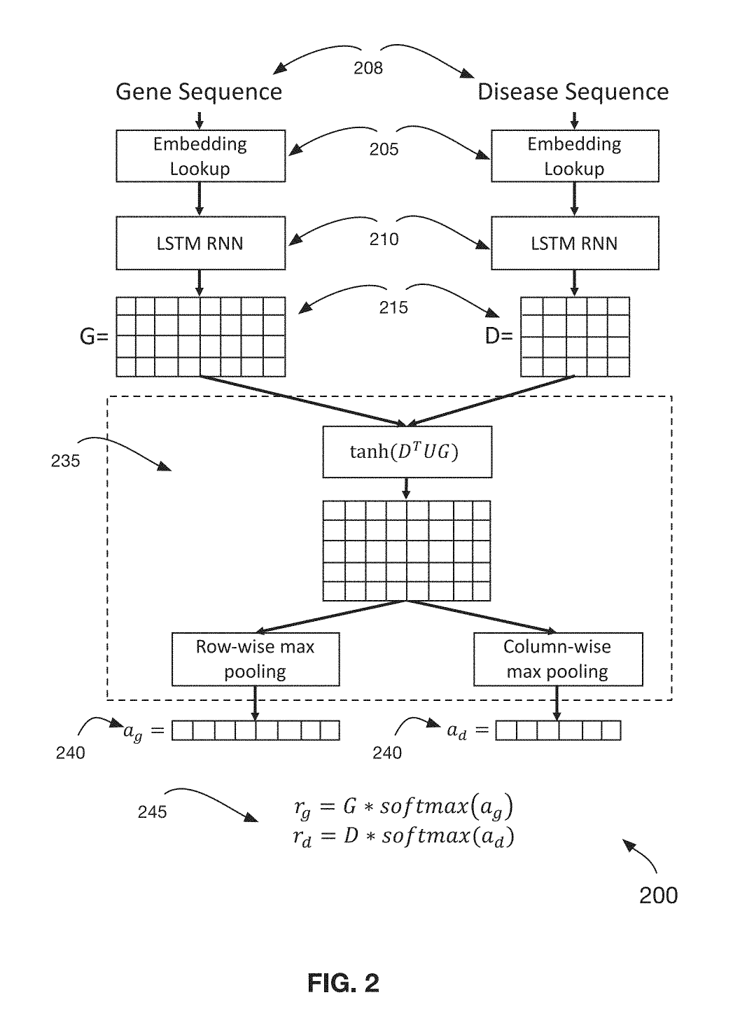

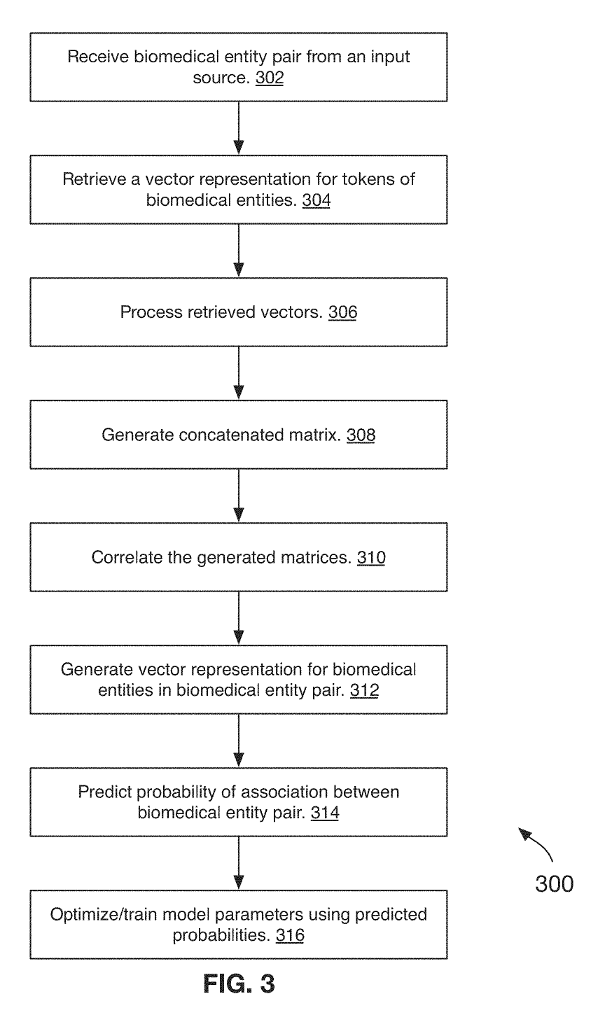

Specific training module 103: Generally, specific training module 103 receives as its input a biomedical entity pair 108, processes that input using a neural network (which may be, for example, the trained neural network 116, if that neural network already exists), and generates an output that represents a measure of association between the biomedical entities in the biomedical entity pair. In this context, biomedical entity pair 108 may be any pairing of biomedical entities from any source. While biomedical entity pairs 108 and knowledge graph 109 are shown separately in FIG. 1, they in fact may be the same component; for example, any two biomedical entities existing in knowledge graph 109 may be selected to form a given biomedical entity pair 108. According to an embodiment of the invention, the processing of the input using a neural network may be done as described in connection with FIGS. 2 and 3, below. The output of the processing, which may also represent the output of specific training module 103, may be used by general training module 104 to train (or retrain) a neural network, such as trained neural network 116.

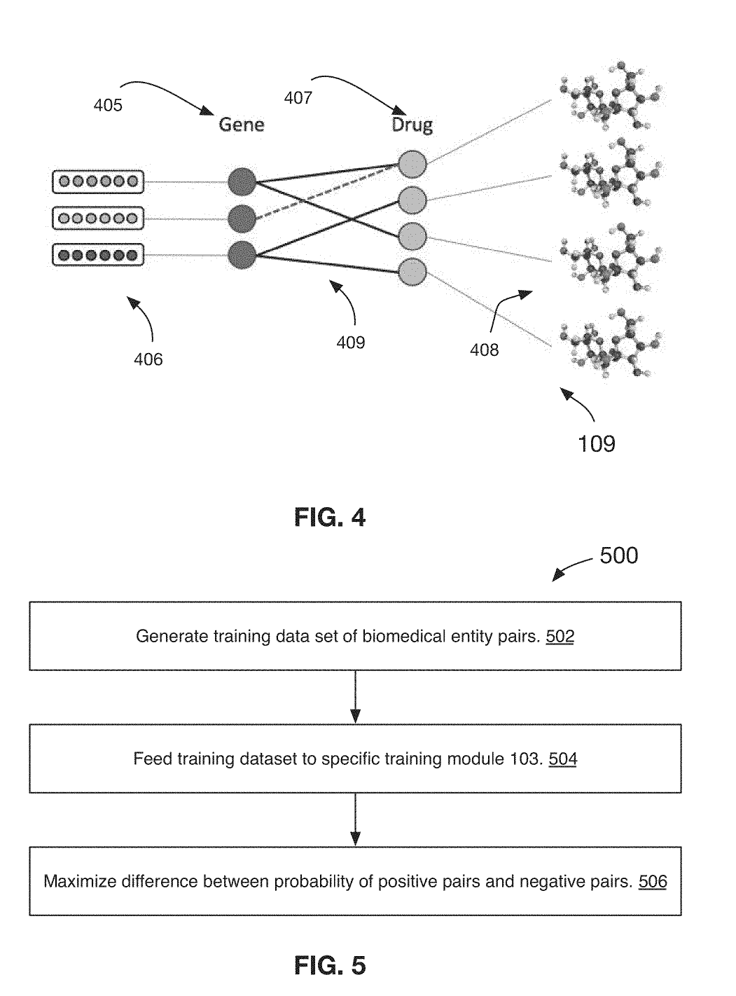

General training module 104: generally, general training module 104 receives as inputs one or more biomedical entity pairs 108 from one or more knowledge graphs 109; that is, general training module 104 generates, or receives a training data set containing pairings of biomedical entities from among the set of biomedical entities represented in knowledge graph 109. For each biomedical entity pair 108 in the training data set, general training module 104 processes the biomedical entities of that pair using known associations (as represented in the knowledge graph) between the two biomedical entities. The processing results in general training module 104 generating and optimizing parameters of trained neural network 116. According to an embodiment of the invention, the processing may be done performed through successive iterations of specific training module 103. Additional details of the operation of general training module 104, as well as the components with which it operates, are provided in connection with FIGS. 4 and 5, below.

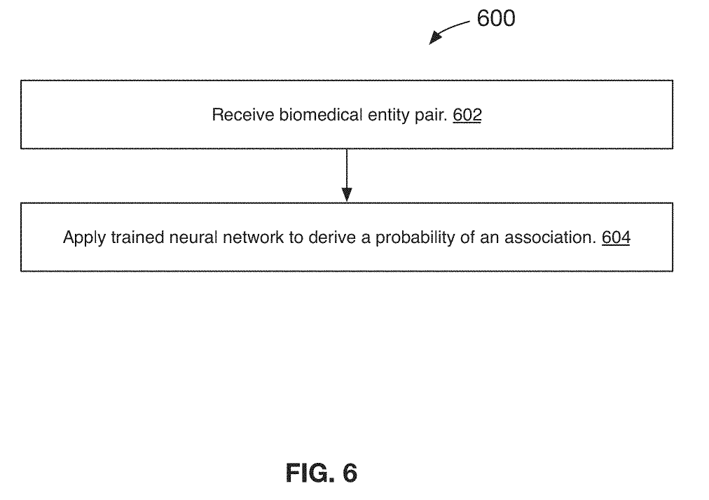

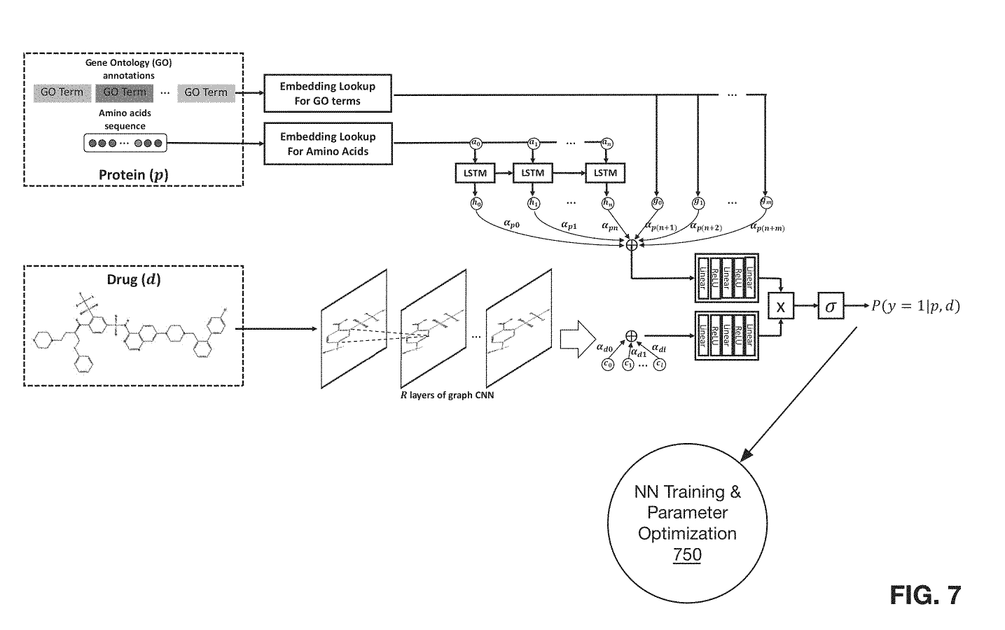

Inference module 112: generally, inference module 112 receives as input a biomedical entity pair 108 and trained neural network 116, processes the biomedical pair 108 using trained neural network 116, and generates link predictions 108. In this context, biomedical entity pair 108 represents a pairing of biomedical entities whose association is not known, and whose association is being predicted. Additional details of inference module 112 and components with which it operates are discussed in connection with FIGS. 6 and 7, below.

FIG. 2 is a functional block diagram 200 of various inputs, outputs, and processing steps of a specific training module 103 of a link prediction program 102 of FIG. 1, according to embodiment of the invention; and FIG. 3 is a flowchart of a method 300 of using specific training module 103 (FIG. 2), according to an embodiment of the invention. Steps of method 300 may be performed by a processor (FIG. 8) executing programming instructions of link prediction program 102, where the programming instructions are stored on a tangible storage device of link prediction system 100.

Referring now to FIGS. 2 and 3, specific training module 103 receives (step 302) biomedical entity pair 208 from an input source, such as from a user, a database, a remote server, or another source. In the example depicted in FIG. 2, the biomedical entities in the biomedical entity pair 208 are one or more gene sequences, and one or more disease sequences, respectively. Specific training module 103 retrieves (step 304), via an embedding lookup layer 205, a vector representation for each token of the biomedical entities 208. An embedding lookup layer generally references a dictionary using the token as a key, and retrieves data (a dense vector representation, in this case) associated with the key. Tokens may be defined differently for each biomedical entity type; for instance, for a gene sequence, each constituent amino acid may be considered a token; for a disease, each word in its description text may be considered a token.

With continued reference to FIGS. 2 and 3, specific training module 103 processes (step 306) the vectors retrieved by the embedding lookup layer 205, by providing the vectors as an input to a neural network 210; in this case, a Long Short Term Memory (LSTM) recurrent neural network (RNN). The processing (step 306) includes each RNN outputting one hidden vector for each input vector it receives, and concatenating (step 308) the hidden vectors to generate respective concatenated matrices 215; denoted by G and D in the depicted example. Each concatenated matrix 215 has as many columns as the number of tokens in its input sequence.

With continued reference to FIGS. 2 and 3, specific training module 103 correlates (step 310) the generated matrices (generated at step 308), for example by using an attentive pooling component 235 that performs row-wise max pooling and column-wise max pooling, to generate two attention vectors 240, one for each input sequence (each corresponding to one of the two biomedical entities in biomedical entity pair 208). Attentive pooling component 235 may perform the operation tanh(D^{T} U G)) that to derive the attention vectors.

With continued reference to FIGS. 2 and 3, for each biomedical entity in biomedical entity pair 208, specific training module 103 generates (step 312) a vector representation 245 corresponding to a weighted sum of the biomedical entity's hidden matrix 215 and the softmax of its attention vector 240. Specific training module 103 predicts (step 314) a probability of an association existing between the input biomedical entities of biomedical entity pair 208 as a function of the various vectors generated; for example by taking the sigmoid of the product of the two vector representations. Specific training module 103 may optionally optimize/train (step not shown) model parameters using iterative outputs of predictions (step 314), together with ground truth data and an optimization algorithm.

With continued reference to FIGS. 2 and 3, and with reference to an illustrative example in which biomedical entity pair 208 includes a gene sequence as a first biomedical entity and a disease sequence (e.g., text describing a disease) as a second biomedical entity, the various inputs, outputs, and processing steps of functional block diagram 200 as used or produce by executing method 300, may be as provided in TABLE 1, below.

TABLE 1
Example inputs, outputs, and processing steps
of functional block diagram 200 and method 300

| | Gene | Disease |
|---|---|---|
| Sequence | (g₁, g₂, g₂) | (d₁, d₂) |
| Embedding (size = 2) | ${e}^{g} = ( \begin{matrix}{e}_{11}^{g} & {e}_{12}^{g} & {e}_{13}^{g} \\ {e}_{21}^{g} & {e}_{22}^{g} & {e}_{23}^{g}\end{matrix} )$ | ${e}^{d} = ( \begin{matrix}{e}_{11}^{d} & {e}_{12}^{d} \\ {e}_{21}^{d} & {e}_{22}^{d}\end{matrix} )$ |
| RNN Output (size = 3) | $G = ( \begin{matrix}{h}_{11}^{g} & {h}_{12}^{g} & {h}_{13}^{g} \\ {h}_{21}^{g} & {h}_{22}^{g} & {h}_{23}^{g} \\ {h}_{31}^{g} & {h}_{32}^{g} & {h}_{33}^{g}\end{matrix} )$ | $D = ( \begin{matrix}{h}_{11}^{d} & {h}_{12}^{d} \\ {h}_{21}^{d} & {h}_{22}^{d} \\ {h}_{31}^{d} & {h}_{32}^{d}\end{matrix} )$ |
| Attention Matrix | $tanh {D}^{T} UG = ( \begin{matrix}{a}_{11} & {a}_{12} & {a}_{13} \\ {a}_{21} & {a}_{22} & {a}_{23}\end{matrix} )$ | |
| Weight Vector | ${a}_{g} = ( {max}_{j} \{ {a}_{j 1} \} {max}_{j} \{ {a}_{j 2} \} {max}_{j} \{ {a}_{j 3} \} )$ | ${a}_{d} = ( {max}_{i} \{ {a}_{1 i} \} {max}_{i} \{ {a}_{2 i} \} )$ |
| Vector Representation | r_{g} = e^{g} × a_{g} | r_{d} = e^{d} × a_{d} |

FIG. 4 is a functional block diagram of a knowledge graph 109 for use with the general training module 104 of the link prediction program 102 of FIG. 1, according to an embodiment of the invention. FIG. 5 is a flowchart of a method 500 for using general training module 104 (FIGS. 1 and 4), according to an embodiment of the invention.

Referring now to FIGS. 4 and 5, general training module 104 has access to a knowledge graph 109, having vertices and edges, from an input source, for further processing. Knowledge graph 109, in the depicted embodiment, may include two sets of biomedical entities: gene entities 405 (each having an associated sequence of tokens 406; in this case, amino acids), and drug entities 407 (each having an associated sequence of tokens 408; in this case, chemical compound). A given gene entity 405 may be associated (linked) or unassociated with a given drug entity 407; associations are represented in the knowledge graph via edges 409. In the depicted embodiment, a known association is shown via a solid-line edge 409, whereas an association that may be predicted (but is not known) is represented via a dashed edge.

With continued reference to FIGS. 4 and 5, general training module 104 generates (step 502) a training data set having one or more biomedical entity pairs 108 a biomedical entity pairs 108. Generating the training set may be performed, in one example, by randomly selecting a group of positive pairs and negative pairs using the link information in knowledge graph 109. The negative pairs can be selected from knowledge graph 109 if the negative links exist, and can otherwise be selected based on user-defined strategies. In one embodiment, negative sampling may be used to generate the negative pairs; in this approach, negative pairs are randomly sampled from non-observed links.

With continued reference to FIGS. 4 and 5, general training module 104 feeds (step 504) the training data set (biomedical entity pair-by-pair) to specific training module 103 (see FIGS. 2 and 3). Recall that an output of specific training module 103, for a given biomedical entity pair 108, is a measure of the entities' association. By feeding the training data set to specific training module 103, general training module generates a set of such measures of entity association.

With continued reference to FIGS. 4 and 5, general training module 104 maximizes (step 506) maximize the difference between the probability of positive pairs and negative pairs using, for example, gradient descent. In other words, positive pairs should get higher probabilities than negative pairs, and, if not, training module 104 adjusts the parameters to achieve that. The results of this processing are stored in trained neural network 116. According to an embodiment of the invention, the maximization may be performed using the following function:

$$argmin {\sum }_{w}^{\\} {\sum }_{u ∈ {N}^{+} ( w ) , v ∈ {N}^{-} ( w )} max \{ 0 , λ - σ ( w , v ) + σ ( w , u ) \}$$

FIG. 6 is a flowchart of a method 600 of using an inference module 112 of the link prediction program 102 of FIG. 1, according to an embodiment of the invention.

Referring now to FIGS. 1 and 6, inference module 112 receives (step 602) a biomedical entity pair 108, for example, e1 and e2, and their basic representations (for example, for a gene, the basic representation may be the gene's amino acid sequence). Inference module 112 applies (step 604) trained neural network 116 to e1 and e2, to derive a probability that an association (link) exists between e1 and e2. According to an embodiment of the invention, the probability of an association existing may be provided using two weighted vectors that explain the degree of contribution of each input to the prediction. For example, if a gene's sequence is (A, B, C), and the output weight vector for the gene is (0.2, 0.5, 0.3), the result indicates that B is the most important for making this contribution, and its importance is weighted by 0.5. According to an embodiment, the probability of association may be given by the following function:

P(y=1|r_{g},r_{d})=σ(g,d)=(1+e^{-r}^{_{g}}^{r}^{_{d}})⁻¹

FIG. 7 is a functional block diagram of an overall data flow and neural network architecture, according to an embodiment of the invention. Referring now to FIG. 7, an interpretable end-to-end neural network model is provided for predicts drug-target identification (DTI) directly from low level representations. In the following discussion, details of several aspects of the embodiments described in connection with FIGS. 1-6 are provided. FIG. 7 is described in the context of an example, where the input of the model are raw amino acids sequences and molecule chemical structures, and, in terms of output, the model produces interpretations optimized for visualization, in addition to the DTI predictions themselves. Long Short Term Memory Recurrent Neural Networks (LSTM RNNs) and graph-based convolutional neural networks are used to project proteins and drugs into dense vector spaces. A two-way attention mechanism (shown as αₚᵢ and α_{di}) is used to calculate how the pair interact and thus enable the interpretability. Finally, the attention-based vector representations are used by a classifier, a simple sigmoid function, to make a prediction. This model is extensible to incorporate high-level information such as Gene Ontology annotations.

Some embodiments of the invention have been tested using a testing dataset. The testing dataset was constructed in a way that simulates the practical situations, where, given a pair of drug and protein at testing time, the drug, the protein, or both of them may have not been observed in the training time. Such experimental setting demands great generalization ability in the underlying model. Evaluated against prior art solutions, embodiments of the invention use less feature engineering and require less domain expertise, and therefore present superior results in the difficult cases not covered well by human designed features, and where neither the drug nor the protein from a testing pair is observed.

With continued reference to FIG. 7, a protein sequence is provided which includes a list of amino acids p=(a₁, . . . , aₙ), where aᵢ may be one of 23 types of amino acids (20 standard, 2 additional, and 1 for unknown). Additionally, each protein sequence has a set of gene ontology (GO) annotations GOₚ={g₁, . . . , gₘ} that give high level information of the protein sequence. Additionally, a drug is represented by a SMILES sequence, which encodes a chemical structure graph d={V, E}, where V is a set of atoms and E is a set of chemical bonds that bind two atoms as undirected edges. The SMILES strings can be transformed to chemical structure graphs using any known method in the art. One goal of drug-target interaction prediction may be to learn a model that takes a pair (p, d) as input and outputs y∈{0,1}, where y=1 indicates that there is an interaction between g and d, and y=0 indicates no interaction.

With continued reference to FIG. 7, a mechanism for using a recurrent neural network is provided. In the situation where protein sequences are represented by amino acids sequences and drugs are represented by SMILES strings, a recurrent neural network (RNN) is used to project sequential inputs to dense vector representations. Specifically, because in reality protein sequences fold in 3-dimensional space, and because SMILES strings are contextual by design, both of which can be viewed as long-distance dependencies, a Long Short Term Memory (LSTM) RNN is used for its ability to memorize long-term information. At each time step t, the LSTM unit takes the t-th input token embedding xₜ∈ [symbol] ^{M} and the cell states from the previous time step h₍ₜ₋₁₎∈ [symbol] _{H}; c₍ₜ₋₁₎∈ [symbol] ^{H} and produces a hidden state hₜ∈ [symbol] ^{H}. Here, M and H are two hyper parameters that specify the dimension of the embedding space and the dimension of the hidden space respectively. The variant of LSTM used is defined as:

iₜ=σ(Wᵢᵢxₜ+Wₕᵢh₍ₜ₋₁₎+bₕᵢ) (1)

fₜ=σ(W_{if}xₜ+b_{if}+W_{hf}h₍ₜ₋₁₎+b_{hf}) (2)

gₜ=tanh(W_{ig}xₜ+b_{ig}+W_{hc}h₍ₜ₋₁₎+b_{hg}) (3)

oₜ=σ(Wᵢₒxₜ+bᵢₒ+Wₕₒh₍ₜ₋₁₎+bₕₒ) (4)

cₜ=fₜ*c₍ₜ₋₁₎+iₜ*gₜ (5)

hₜ=oₜ*tanh(cₜ) (6)

where Wᵢ, Wₕ, bᵢ, and bₕ are learning parameters, and where h₀=0_{H} is initialized as a vector of zeros. Suppose now that the input tokens belong to a vocabulary V=|{t₁, . . . , t_{|v|}}, the input embeddings are obtained as:

xᵢ=Wᵥ^{T}Iᵢ (7)

where Wᵥ∈ [symbol] ^{|v|×M} is a learnable parameter and Iᵢ∈ [symbol] ^{|v|×1} is a vector whose i-th value is one and all other values are zero.

With continued reference to FIG. 7, when drugs are represented by chemical structure graphs, a convolutional neural network (CNN) may be used to project chemical structure graphs to dense vector representations. This may be more intuitive than using RNN to model drugs because it eliminates the step of linearizing the graph structures into SMILES strings. As a differentiable generalization of circular fingerprint, the CNN-based neural fingerprint may provide more descriptive drug modeling in a data-driven manner. The process of providing a neural graph fingerprint may be provided, for example, using Algorithm 1, provided below in pseudocode:

Algorithm 1: Pseudocode of the neural graph fingerprint algorithm

| | Input: molecule graph G = (V, E), radius R, hidden | | |
|---|---|---|---|
| | weights H₁¹ . . . H_{R}⁵ output weights W₁ . . . W_{R} | | |
| | Output: fingerprint vector f | | |
| | Initialize: fingerprint vector f ← Oₙ | | |
| 1 | for each node a ϵ V do | | |
| 2 | \| | rₐ ← g(a); // g maps atom features to | |
| | \| | sparse vector | |
| 3 | end | | |
| 4 | for L = 1 to R do | | |
| 5 | \| | for each node a ϵ V do | |
| 6 | \| | \| | [symbol] = neighbors(a); |
| 7 | \| | \| | v ← rₐ + [symbol] rᵤ; |
| 8 | \| | \| | rₐ ← σ(vH_{L}^{\|N\|}); |
| 9 | \| | \| | f ← f ← softmax(rₐW_{L}); |
| 10 | \| | end | |

| | |
|---|---|
| 11 | end |

Algorithm 1 shows the pseudo-code of the neural fingerprint algorithm that produces a dense vector representation from the input molecule graph, and as a side effect it also assigns a dense vector representation for each atom in the molecule. At the initialization phase (line 1, 2 in Algorithm 1), the atom features are initialized as a 62-dimension sparse vector that indicates both chemical and topological properties of the atom. The algorithm then iteratively applies convolutional operation on the graph (lines 4-10 in Algorithm 1) R times and updates the fingerprint at the end of each iteration. The radius parameter R controls how many hops can information be propagated, and it is set to (3) in this instance.

While the CNN is usually applied on a matrix, for example images, Algorithm 1 is convolutional in the sense that it applies filters to each atom and its neighborhood to capture a local signal, and then the aggregated local signals are pooled to get the final vector representation. In contrast to an image in which each pixel always has 8 neighbor pixels, an atom can have from one to five neighbor atoms. Therefore, instead of using one convolutional filter, Algorithm 1 uses 5 linear filters H₁ . . . H₅ for atoms with a corresponding number of neighbors. At the end of each iteration, the fingerprint is updated by adding the softmax of a linear transformation of each atom vector, and the linear transformation for each layer is defined by learnable parameters W_{L}∈ [symbol] ^{62×H}, L=1, . . . , R.

With continued reference to FIG. 7, functions may be provided for attentive pooling, as follows. Neural networks with attention mechanism have been effectively applied to vision tasks such as image captioning and natural language processing tasks such as machine translation, where the output components selectively choose information from the input based on the attention weights. Extending the one-way attentive pooling for pairwise inference, an attentive pooling network provides a two-way attention mechanism that enables the input pairs to be aware of each other.

For example, suppose P∈ [symbol] ^{H}ₚ^{xL}ₚ is the context matrix of a given protein, where Hₚ, Lₚ are the dimensions of the protein hidden space and the number of inputs, it can be formed in 3 ways as proteins have two input sources: (1) the concatenation of LSTM hidden vectors with amino acids sequences input so that Lₚ equals the number of amino acids in the sequence; (2) the concatenation of GO annotations embeddings so that Lₚ equals the number of GO terms for the protein; and (3) the concatenation of both (1) and (2).

Similarly, suppose D∈ [symbol] ^{H}_{d}^{xL}_{d} is the context matrix of a given drug, H_{d}, L_{d} being the dimensions of the drug hidden space and the number of inputs; it can be (1) the concatenation of LSTM hidden vectors with SMILES string input so that L_{d} equals the number of tokens in the SMILES string, or (2) the concatenation of atom vectors obtained from graph CNN so that L_{d} equals to the number of atoms in the molecule.

A soft alignment matrix A∈ [symbol] ^{L}ₚ^{xL}_{d} is calculated as A=tanh(P^{T} U D), where U∈ [symbol] ^{H}ₚ^{xH}_{d} is a trainable parameter. For an intuitive example, when proteins are represented by amino acid sequences and drugs by chemical structure graphs, A empirically represents the interaction between each amino acid and each atom.

Next, the attention weights αₚ∈ [symbol] ^{L}ₚ, α_{d}∈ [symbol] ^{L}_{d}, which can be interpreted as importance scores on the input units, are calculated by applying row-wise and column-wise maxpooling operations to A:

$$\begin{matrix}{[ {α}_{p} ]}_{i} = {max}_{1 \leq j \leq {L}_{d}} {A}_{i , j} & ( 8 ) \\ {[ {α}_{d} ]}_{j} = {max}_{1 \leq i \leq {L}_{p}} {A}_{i , j} & ( 9 )\end{matrix}$$

Finally, αₚ and α_{d} are exponentially normalized by a softmax function, the results of which are used as weights to generate weighted sum the context vectors:

rₚ=P·softmax(αₚ) (10)

r_{d}=D·softmax(α_{d}) (11)

where the softmax function is defined as:

$${[ softmax ( v ) ]}_{i} = \frac{{e}^{{v}_{i}}}{{\sum }_{j} {e}^{{v}_{j}}} \qquad ( 12 )$$

With continued reference to FIG. 7, inference functions using a Siamese network may be implemented as follows. A Siamese network has two input multilayer networks and one output whose value corresponds to the similarity, possibility of interaction in the case of this discussion, between an input pair. As shown in FIG. 7, two networks with 3 linear layers and 2 rectifier layers are used. To reduce the hyper-parameter space, all the linear layers may be required to have the same input and output dimension Hₛ except the first one, whose input dimension corresponds to previous outputs.

The attention-based vector representations rₚ and r_{d} are fed separately into the two networks. Then the inner product of the outputs may be taken, and a sigmoid function may be used to predict the probability that a binding exists between a pair of protein and drug:

$$\begin{matrix}{v}_{p} = {f}_{p} ( {r}_{p} ) & ( 13 ) \\ {v}_{d} = {f}_{d} ( {r}_{d} ) & ( 14 ) \\ P ( y = 1 \vert p , d ) = σ ( p , d ) = \frac{1}{1 + {e}^{- {v}_{p} \cdot {v}_{d}}} & ( 15 )\end{matrix}$$

where fₚ, fₚ are the transformations of the siamese networks for protein and drugs, respectively.

In a classification scenario, a hyper-parameter threshold δ is selected as classification boundary:

$$y = \{ \begin{matrix}1 & if P ( y = 1 \vert p , d ) > δ \\ 0 & otherwise\end{matrix} \qquad ( 16 )$$

With continued reference to FIG. 7, training functions may be implemented as follows. Given a dataset D={(pᵢ, dᵢ))}, i=1 . . . n, the model can be trained by maximizing the likelihood of observing the training data, which is equivalent to minimizing the logarithmic loss function:

$${arg min}_{Θ} {\sum }_{i}^{n} log ( 1 + exp ( - {v}_{g} \cdot {v}_{d} ) ) \vert \qquad ( 17 )$$

where Θ is the set of neural network parameters described above. However, although the discussed examples use a dataset with both positive and negative pairs, negative pairs are usually not available for similar tasks especially when a dataset is from a knowledge graph that stores only existing triples. Therefore, a pairwise ranking loss may be employed, which, for each given protein p, maximizes the margin between interacting drugs and non-interacting drugs, i.e. ranking positive drugs higher than negative drugs as much as possible.

$${arg min}_{Θ} {\sum }_{{d}_{+} ∈ {N}^{+} ( p )} {\sum }_{{d}_{-} ∈ {N}^{-} ( p )} max ( 0 , γ + σ ( p , {d}_{-} ) - σ ( p , {d}_{+} ) ) \qquad ( 18 )$$

where γ>0 is a hyper-parameter that specifies the width of the margin, and N⁺(p) and N⁻(p) give the set of drugs that interact with p and those that do not interact with p, respectively. In this setting, the training only emphasizes the observed positive examples so that negative examples can be generated by sampling pseudo-negative drugs with heuristic criteria, if a dataset does not have any.

Additional neural network training and parameter optimization 750 may be performed according to any known method in the art of neural network optimization (for example, at step 316 shown in FIG. 3), to optimize parameters of the neural network.

FIG. 8 is a functional block diagram of hardware and software components of link prediction system 100, according to an embodiment of the invention. Referring now to FIG. 8, a schematic of an exemplary computing device (which may be a cloud computing node) is shown, according to an embodiment of the invention. Computing device 10 is only one example of a suitable cloud computing node and is not intended to suggest any limitation as to the scope of use or functionality of embodiments of the invention described herein. Computing device 10 is an example of one or more devices of link prediction system 100 (FIG. 1).

In computing device 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 12 in computing device 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Referring now generally to embodiments of the present invention, the embodiments may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for using a neural network model for determining an association between biomedical entities in a biomedical entity pair, comprising:
generating, by a computer, vector representations of respective tokens of biomedical entities of the biomedical entity pair;
generating, using a neural network, hidden vectors for the vector representations to generate hidden matrices;
concatenating the hidden matrices and generating respective concatenated matrices;
correlating the concatenated matrices; and
predicting a probability of an association between the biomedical entities of the biomedical entity pair based at least in part on respective attention vectors generated using the concatenated matrices.

2. The method of claim 1, wherein generating vector representations of biomedical entities of the biomedical entity pairs comprises processing tokens of the biomedical entities via an embedding lookup layer.

3. The method of claim 1, wherein a biomedical entity comprises a data representation of a composition of matter that is related to the fields of biology and medicine.

4. The method of claim 1, wherein the neural network is a Long Short Term Memory (LSTM) recurrent neural network (RNN).

5. The method of claim 1, wherein correlating the concatenated matrices comprises performing attentive pooling on the concatenated matrices.

6. The method of claim 5, wherein the attentive pooling comprises row-wise attentive pooling and column-wise attentive pooling.

7. The method of claim 6, further comprising: generating attention vectors, corresponding to the biomedical entity pairs, based on the attentive pooling.

8. The method of claim 1, further comprising: repeating, iteratively, steps of the method using a training dataset; and optimizing parameters of the neural network to maximize the predicted probability of an association for the training dataset.

9. The method of claim 8, further comprising: processing a new biomedical entity pair not appearing in the training set and for which a prior association is not known; and determining a probability of association between biomedical entities of the new biomedical entity pair.

10. A computer system for using a neural network model for determining an association between biomedical entities in a biomedical entity pair, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
generating vector representations of respective tokens of biomedical entities of the biomedical entity pair;
generating, using a neural network, hidden vectors for the vector representations to generate hidden matrices;
concatenating the hidden matrices and generating respective concatenated matrices;
correlating the concatenated matrices; and
predicting a probability of an association between the biomedical entities of the biomedical entity pair based at least in part on respective attention vectors generated using the concatenated matrices.

11. The system of claim 10, wherein a biomedical entity comprises a data representation of a composition of matter that is related to the fields of biology and medicine.

12. The system of claim 10, wherein the neural network is a Long Short Term Memory (LSTM) recurrent neural network (RNN).

13. The system of claim 10, wherein correlating the concatenated matrices comprises performing attentive pooling on the concatenated matrices.

14. The system of claim 13, wherein the attentive pooling comprises row-wise attentive pooling and column-wise attentive pooling.

15. The system of claim 10, further comprising: generating attention vectors corresponding to the biomedical entity pairs.

16. The system of claim 10, further comprising: repeating, iteratively, execution of the programming instructions using a training dataset; and optimizing parameters of the neural network to maximize the predicted probability of an association for the training dataset.

17. A computer program product for using a neural network model for determining an association between biomedical entities in a biomedical entity pair, the computer program product comprising a non-transitory tangible storage device having program code embodied therewith, the program code executable by a processor of a computer to perform a method, the method comprising:
generating, by the processor, vector representations of respective tokens of biomedical entities of the biomedical entity pair;
generating, by the processor, using a neural network, hidden vectors for the vector representations to generate hidden matrices;
concatenating, by the processor, the hidden matrices and generating respective concatenated matrices;
correlating, by the processor, the concatenated matrices; and
predicting, by the processor, a probability of an association between the biomedical entities of the biomedical entity pair based at least in part on respective attention vectors generated using the concatenated matrices.

18. The computer program product of claim 17, wherein a biomedical entity comprises a data representation of a composition of matter that is related to the fields of biology and medicine.

19. The computer program product of claim 17, wherein the neural network is a Long Short Term Memory (LSTM) recurrent neural network (RNN).

20. The computer program product of claim 17, further comprising: repeating, by the processor, iteratively, steps of the method using a training dataset; and optimizing parameters of the neural network to maximize the predicted probability of an association for the training dataset.
